(19) United States
(12) Patent Application Publication
(10) Pub. No.: US 2024/0240017 A1
(43) Pub. Date: Jul. 18, 2024

(54) POLYMERIC ANTISTATIC AGENT-CONTAINING RESIN COMPOSITION AND MOLDED BODY

(71) Applicant: Akimoto Seisakusyo Co., Ltd., Kashiwa-shi (JP)

(72) Inventors: Masanori OHKUBO, Kashiwa-shi (JP); Kazumasa YAMAZAKI, Noda-shi (JP)

(73) Assignee: Akimoto Seisakusyo Co., Ltd., Kashiwa-shi (JP)

(21) Appl. No.: 18/562,594

(22) PCT Filed: Oct. 15, 2021
(86) PCT No.: PCT/JP2021/038230

§ 371 Date: Nov. 20, 2023

(51) Int. Cl. C08L 71/12

(52) U.S. Cl. CPC C08L 71/12; C08L 2201/04; C08L 2203/20; C08L 2205/035; C08L 2205/08

(57) ABSTRACT

A resin composition may contain an A resin, a B resin, a C resin and a polymer antistatic agent. The A resin may be a polyphenylene ether resin. The B resin may be a styrene resin. The C resin may be one or more of resins selected from carbonate resins, acrylic resins, amide resins, butylene terephthalate resins, and ethylene terephthalate resins. The polymer antistatic agent may be 5-30 parts by mass per 100 parts by mass of the A resin. The B resin may be 5-40 parts by mass per 100 parts by mass of the A resin. The C resin may be 30-240 parts by mass per 100 parts by mass of the B resin.

### TECHNICAL FIELD

The present invention relates to a resin composition and a molded body. The molded body is a container (also referred to as “tray”) to be used for storing, for example, electronic products (e.g., semiconductor elements (transistors or ICs), and other electronic parts), for transporting the electronic products, or for setting the electronic products on a mounted device (or in an inspection tool).

### BACKGROUND ART

When transporting the electronic products or when setting the electronic products on the automated mounted device (or in the characteristic inspection tool) or, alternatively, when storing the electronic products, the electronic products are accommodated in a storage area of a synthetic resin tray. JP1993-16984A (PATENT LITERATURE 1) discloses an example of the tray. FIG. 1 is a perspective view illustrating a state that a plurality of trays is stacked. FIG. 2 is a cross section taken along the line I-I of FIG. 1. In FIG. 1 and FIG. 2, 1 denotes a tray, 2 denotes a product (parts) storage area, 3 denotes a convex edge portion, 4 denotes a concave edge portion, and 6 denotes an electronic part (see, PATENT LITERATURE 1). JP2005-88995A (PATENT LITERATURE 2) discloses an example of the tray. FIG. 3 is a plan view illustrating the tray. There is also such a case that a plurality of the trays is stacked upon the use thereof. In FIG. 3, 1 denotes a tray, 2 denotes a product storage area, 3 denotes a convex edge portion, and 4 denotes a projecting claw (see, PATENT LITERATURE 2).

In a case where a case for the electronic products is made of a resin, there is a problem of a dust adhesion because of an occurrence of static electricity (electrostatic charge). Also, there is a problem of an obstruction because of discharge. JP1992-246461A (PATENT LITERATURE 3). JP1995-228765A (PATENT LITERATURE 4), JP2002-212414A (PATENT LITERATURE 5), JP2010-229348A (PATENT LITERATURE 6), and JP2012-31395A (PATENT LITERATURE 7) propose a molding of the case by using an antistatic agent-containing resin composition. The PATENT LITERATURES 3, 4, 5, 6, and 7 propose to use a polyphenylene ether (PPE)-based resin as the case constituent material. As an antistatic agent, for example, a conductive filler (carbon black (CP), carbon fiber (CF), carbon nanotube (CNT), metal powder (MP), metal fiber (MF), etc.), a surfactant (Surface Active Agent: SAA), and a polymeric antistatic agent (Polymer Antistatic Agent: PAA) are known. In a case where the case is molded by using the antistatic agent-containing resin composition, it is expected that the problem of the occurrence of static electricity (electrostatic charge) is improved. JP1989-156A (PATENT LITERATURE 8) and JP1989-65167 (PATENT LITERATURE 9) propose a polyphenylene ether (PPE)-based resin composition.

### CITATION LIST

### Patent Literature

### [Patent Literature 1]

JP 1993-16984A

### [PATENT LITERATURE 2]

JP 2005-88995A

### [PATENT LITERATURE 3]

JP 1992-246461A

### [PATENT LITERATURE 4]

JP 1995-228765A

### [PATENT LITERATURE 5]

JP 2002-212414A

### [PATENT LITERATURE 6]

JP 2010-229348A

### [PATENT LITERATURE 7]

JP 2012-31395A

### [PATENT LITERATURE 8]

JP 1989-156A

### [PATENT LITERATURE 9]

JP 1989-65167A

### SUMMARY OF INVENTION

### Technical Problem

As the antistatic agent, CP, CF, CNT, MP, MF, SAA, PAA, etc., are known.

The conductive filler (CP, CF, CNT, MP, and MF) could be blended with various kinds of resins. In a case where a polyphenylene ether (PPE), a polyether sulfone (PES), a polysulfone (PSU), a polyarylene sulfide (PAS), etc., are used, an excellent heat resistance property (heat distortion temperature) could be obtained. A surface electrical resistance value was low.

In a case where the conductive filler was used, due to rubbing against another tray (friction between the trays, and friction between the tray and the electronic products accommodated in the tray), dropout of or falling powder from the filler occurred. Contamination occurred. In a case of CF and MF, protrusion and/or breakage of the CF and the MF occurred. The surface electrical resistance of the tray increased. The contamination occurred to the tray. In a case where the CP was used, due to the powdery CP, a high degree of contamination occurred. In a case where the CNT was used, such a problem was more or less improved. In a case where the filler adheres onto the tray surface, the filler sometimes moves to the electronic products from the tray surface. In this case, because the filler has an electrical conductivity, such a problem arises that the characteristics of the electronic products is degraded.

A resin composition blended with the conductive filler had a bad flow behavior upon molding. The molding processability was degraded. The appearance of the molded products is not good. The molded products had problems of surface peeling, surface roughening, etc.

The conductive filler-containing resin composition has a dark color (e.g., black). It is far from a bright color. Trays having various colors cannot be obtained. This makes it impossible to accommodate the electronic products in trays having different colors according to the kinds (model numbers, etc.) of the electronic products.

In a case where the SAA was used as the antistatic agent, in comparison with the case where the conductive filler was used, the characteristics (e.g., water absorption property, heat resistance property, surface electrical resistance property, and durability) were inferior. When the tray was heated, the SAA bleed out a lot. A problem of contamination of the electronic products was serious.

In a case where the PAA was used as the antistatic agent, the problem which occurred when the conductive filler was used hardly occurred. The problem of bleed out which occurred when the SAA was used hardly occurred. There was no problem in the characteristics such as a lightweight property, a water absorption property, and a surface electrical resistance. There was no such a problem in flow behavior of the resin composition upon molding. There was no problem of degradation in appearance such as surface peeling and surface roughening of the tray. Trays having different colors can be obtained with ease. This makes it possible to accommodate the electronic products in trays having different colors according to the kinds (model numbers, etc.) of the electronic products.

In a case where the PAA was used, in comparison with the case of using the conductive filler, generally, the heat resistance property was inferior. Only the resin composition having a low heat distortion temperature (HDT) could be obtained. The resin composition having a high HDT like the case where the resin composition contained the conductive filler could not be obtained.

The present invention is directed to provide a resin composition suitable for the container (tray). The present invention is directed to provide a resin composition in which kneading and molding of a resin compound can be performed at a temperature of, for example, 290° C. or lower. The present invention is directed to provide a resin composition having a HDT of, for example, 135° C. or higher. The present invention is directed to provide a resin composition having a water absorption rate of, for example, 0.8% or lower. The present invention is directed to provide a resin composition having a specific gravity of, for example, 1.0-1.1. The present invention is directed to provide a resin composition having a surface electrical resistance value of, for example, 1.0×10¹²Ω or smaller. The present invention is directed to provide a resin composition having high cleanability. The present invention is directed to provide a resin composition which can be made into a molded body of not a dark color (brown or black) but another colors (e.g., white or bright colors).

### Solution to Problem

As a result of a keen study of the inventor, it is found that the resin composition satisfying the below mentioned (1) to (7) elements is suitable for producing the container (tray) which accommodates the electronic products (electronic parts (e.g., semiconductor elements (transistors or ICs, etc.), other electronic parts), etc.).

### (1) Tray Color

When using the CP, CF, CNT. MP, and MF, the tray color becomes black or dark color, and thus the appearance thereof is not good. The antistatic agent having a color other than black or dark color was desired. A colorable (color discriminable) “clean tray” was desired. Upon storage, etc., of the electronic products, if the electronic products can be accommodated in “clean trays” of desired colors (i.e., trays discriminable by colors) according to the kinds of the electronic products, an easy classification can be achieved. In producing process or product management of the electronic products, the electronic products can be readily discriminated.

That is, handling of the electronic products can be improved.

When the CP, CF, CNT, MP, and MF were used, the resin composition bad a bad flow behavior. Moldability was degraded.

The resin composition containing the polymeric antistatic agent was inferior in the electrostatic charge prevention property to the resin composition containing the CP, but the problem of contamination, etc., could be improved. It was possible to obtain the “clean trays” of desired colors (i.e., trays discriminable by colors).

### (2) Contamination (Contamination Due to Dropout, Falling Powder, and Raising Dust; Contamination by Protrusion or Breakage of Fibers)

It was a material factor that the contamination (contamination by falling powder and raising dust from the antistatic agent (conductive material) contained in the tray constituent resin and contamination by protrusion and breakage of the fibers) hardly occurred due to rubbing (friction between the trays and/or friction between the tray and the electronic products accommodated in the tray).

The tray made of the resin composition blended with CP, CF, CNT, MP, MF, etc., as the antistatic agent, has a satisfactory high HDT (heat resistance property) and a sufficiently low surface electrical resistance value. But the rubbing causes the contamination. In the tray made of the resin composition blended with SAA as the antistatic agent, the SAA contained in the tray constituent resin bleeds out. The bled-out SAA adheres to the tray surface and, thereafter, moves to the electronic products accommodated in the tray. This degrades the electrical characteristic of the electronic products.

A substance as a substitute for the CP, CF, CNT, MP, MF, and SAA was demanded, and “clean tray” was desired.

The resin composition containing the PAA, in comparison with the resin composition containing the CP, was inferior in the electrostatic charge prevention property, but the problem of the contamination, etc., could be improved largely. A “clean tray” could be obtained.

In this point of view, it was preferred not to use the CP, CF, CNT, MP, MF, and SAA.

The contamination is determined by <Pencil Hardness (Blackness)> described in the following [Evaluation Point; Evaluation Method].

### (3) Heat Distortion Temperature (HDT (Heat Distortion Temperature; Heat Resistance Property))

JP1995-228765A (PATENT LITERATURE 4) discloses that a resin composition made of PPE (polyphenylene ether-based resin), or a resin composition made of PPE and HIPS (styrene-based resin) and MRF (styrene-based resin modified by glycidyl (meth)acrylate), and an antistatic agent having a specific structure has a HDT of 93-100° C.

As a content of a polymer type antistatic agent (PAA) in the resin composition increased, the surface electrical resistance could be suppressed to a low level, while the HDT became low. The HDT of the resin composition blended with the PAA was generally about up to 120° C.

In the resin composition of the tray for accommodating the electronic products, preferably, the HDT (according to the ISO75) was 135° C. or higher. More preferably, it was 140° C. or higher. Further preferably, it was 150° C. or higher.

But only the use of the resin of the high HDT was not the material factor.

The HDT of the resin is shown below.
HDT of polyethylene terephthalate (PET)=21-66° C.
HDT of polypropylene (PP)=40-60° C.
HDT of polybutylene terephthalate (PBT)=50-85° C.
HDT of polyamide (PA)=65-104° C.
HDT of polymethyl acrylate (PMMA)=68-100° C.
HDT of polystyrene (PS)=72-94° C.
HDT of acrylonitrile-styrene copolymer (SAN)=88-104° C.
HDT of acrylonitrile-butadiene-styrene copolymer (ABS)=94-107° C.
HDT of polyphenylene sulfide (PPS)=100-135° C.
HDT of polycarbonate (PC)=121-132° C.
HDT of polyacetal (POM)=123-136° C.
HDT of polyallylate (PAR)=150-180° C.
HDT of polyether ether ketone (PEEK)=156-160° C.
HDT of polysulfone (PSU)=174-190° C.
HDT of liquid crystal polymer (LCP)=174-190° C.
HDT of polyphenylene ether (PPE)=187-191° C.
HDT of polyether sulfone (PES)=196-203° C.
HDT of polyether imide (PEI)=197-210° C.
HDT of polyarylene sulfide (PAS)=255-280° C.
HDT of polyamide imide (PAI)=278° C.

### (4) Kneading Temperature: Temperature During Molding Process

A starting temperature for thermal decomposition of the PAA is about 285° C. If the kneading temperature and the temperature during molding process of the resin compound is high, the PAA is decomposed. An antistatic effect decreases. The thermal decomposition of the PAA causes generation of a gas. The generated gas degrades an appearance of the molded products.

From this point of view, preferably, the kneading temperature and the temperature during molding process of the resin compound was 290° C. or lower.

The temperature for thermal decomposition of the antistatic agent such as CP, CF, and CNT is 500° C. or higher. Therefore, the use of the CP, CF, CNT, etc., does not cause a problem in kneading and injection molding process at a high temperature. PPE, PES, PSU. PAS, etc., having a high melting temperature of resin and a high HDT are employable. A resin composition having a HDT of 150° C. or higher can be obtained with ease.

To the contrary, in a case where the PAA is used as the antistatic agent, a different situation arises. As the thermoplastic resin capable of being subjected to kneading and molding of resin compound at the temperature of 285° C. or lower, PS (melting temperature of resin=163-316° C.) is exemplified. ABS (melting temperature of resin=177-316° C. is exemplified. SAN (melting temperature of resin=191-316° C.) is exemplified. PC (melting temperature of resin=273-328° C.) is exemplified. But the above resins have a low HDT.

The inventor repeatedly studied aiming at the development of the resin composition of which HDT is 135° C. or higher and of which kneading temperature and temperature during molding process were 290° C. or lower when using a polymer type antistatic agent (PAA) which hardly raised the problem like a case where the CP, etc., were used. As a result, the inventor found that the resin composition composed of A resin (PPE (melting temperature of resin=220-350° C.; HDT=187-191° C.)) as a main resin, B resin (styrene-based resin), and C resin (one or more resin selected from the group consisting of a carbonate-based resin, an acrylic-based resin, an amide-based resin, a butylene terephthalate-based resin, and an ethylene terephthalate-based resin) hardly raised the problem of thermal decomposition of the PAA as well as enabled the kneading and the molding processing of the resin compound even at the starting temperature (285° C.) of the thermal decomposition.

### (5) Surface Electrical Resistance

The resin composition blended with the conductive filler (CP, CF, CNT, MP, and MF) has a low surface electrical resistance value. There is a case where, depending on the blended amount, the resin composition has the surface electrical resistance value of about 10⁴Ω. It has less problem of static electricity. From this point of view, the use of CP, CF, CNT, MP, and MF is convenient.

The resin composition containing the polymeric antistatic agent (PAA) has a higher surface electrical resistance value than the resin composition containing CP, etc. There is a case where, depending on the content of PAA, the resin composition containing PAA has the surface electrical resistance value of about 10¹²Ω.

According to the study of the present inventor, even when the surface electrical resistance value was about 10¹²Ω, the problem was small. The “surface electrical resistance value (IEC 60093)≤1.0×10¹²Ω” hardly raised a problem.

The “surface electrical resistance value (IEC 60093)≤1.0×10¹²Ω” means as follows. The antistatic agent can be selected from a wide range. The addition of the antistatic agent can be reduced. Reduction of the content of PAA is preferable for the following reasons. The HDT could be improved. The water absorption rate could be decreased. Owing to the decrease of water absorption rate, the dimensional accuracy and the stabilization in dimension of the molded body could be improved. A small abrasion (swelling) on the surface of the molded body could be reduced. The strength degradation could be prevented.

To produce the above-mentioned effect, the decrease of the content of the polymeric antistatic agent (PAA) was material. This could be achieved by adjusting the blending ratio of the A resin (PPE), the B resin (styrene-based resin), and the C resin (one or more resin selected from the group consisting of a carbonate-based resin, an acrylic-based resin, an amide-based resin, a butylene terephthalate-based resin, and an ethylene terephthalate-based resin).

### (6) Water Absorption Rate

The present inventor has not found any literature which studies about the tray from the perspective of the water absorption rate.

The CP, CF, NT, MP, MF, etc., has an extremely small water absorption rate. The CF has a water absorption rate of 0.05%. The PAA has a water absorption rate of 2-3%. The value (2-3%) is larger than a water absorption rate of the thermoplastic resin.

PATENT LITERATURE 4 discloses to the effect that “The PPE resin composition containing a large amount of polyalkylene oxide (antistatic agent) shows problems of the strength degradation, delamination, and impact resistant strength in the molded product”.

The dimensional accuracy and the stabilization in dimension are material factors for the tray accommodating the electronic products. In a case of storing or transporting the electronic parts in the tray, there are many cases where trays accommodating electronic parts are stacked (several trays to ten or more trays). Therefore, the dimensional accuracy is material in length (long, short, fitting portion, etc.), thickness (total height, height of fitting portion)), etc., of the trays. Minimum warpage, deformation, etc., are desired. Upon setting the trays accommodating the electronic parts on a mounted device (or in an inspection tool), the trays are fitted in to a jig on the device side. Upon setting (fitting), the trays need to have a size corresponding to the jig. Therefore, in the trays, the dimensional accuracy and the stabilization in dimension are important.

According to the ISO Fixed Dimension (f) for regulating dimensional tolerance, in a case of a size of 120 mm-400 mm, the general tolerance is standardized to #0.2 mm. The general tolerance of a product to which more strict dimensional accuracy is demanded is standardized to #0.15 mm. The JEDEC Standards (JEDEC Solid State Technology Association in the US (corresponding to the JEITA Standards in JP)) for regulating a dimension of IC tray standardizes the dimensional tolerance in such a manner that the dimensional tolerance of a long side of 315.0 mm is ±0.25 mm and the dimensional tolerance of a short side of 135.9 mm is ±0.25 mm.

To satisfy the standards, it has been recognized that the water absorption rate is a material factor for the dimensional accuracy and the stabilization in dimension. It has been recognized that the water absorption rate is an important factor for satisfying the dimensional accuracy and the stabilization in dimension of the tray made of the resin composition and for avoiding degradation in appearance and lowering of physical properties in strength. According to the repeated experiments performed by the inventor, in the tray made of resin composition having a water absorption rate of 0.8% or less, the problem was improved. The resin composition having a water absorption rate of 0.63% or less was more preferred. The resin composition having a water absorption rate of 0.55% or less was further preferred. The resin composition having a water absorption rate of 0.47% or less was specially preferred.

In the water absorption rate, a selection and a blend ratio of resins constituting the resin composition was extremely important.

The water absorption rate was calculated as follows. A substrate of 75 mm×75 mm×3 mm (thickness) was produced, and a water absorption rate of the substrate was measured under the condition (ISO62).

The water absorption rate of resin is as follows.
water absorption rate of liquid crystal polymer (LCP)=0.002%
water absorption rate of polypropylene (PP)=0.01-0.03%
water absorption rate of polystyrene (PS)=0.01-0.07%
water absorption rate of polyphenylene sulfide (PPS)=0.01-0.07%
water absorption rate of polyphenylene ether (PPE)=0.05-0.07%
water absorption rate of polybutylene terephthalate (PBT)=0.08-0.09%
water absorption rate of polyether ether ketone (PEEK)=0.10-0.14%
water absorption rate of polyethylene terephthalate (PET)=0.09-0.20%
water absorption rate of acrylic-based resin (PMMA)=0.10-0.40%
water absorption rate of polyether sulfone (PES)=0.12-0.43%
water absorption rate of polycarbonate (PC)=0.15%
water absorption rate of acrylonitrile-styrene copolymer (SAN)=0.20-0.30%
water absorption rate of acrylonitrile-butadiene-styrene copolymer (ABS)=0.20-0.45%
water absorption rate of polyether imide (PEI)=0.25%
water absorption rate of polyacetal (POM)=0.25-1.00%
water absorption rate of polyallylate (PAR)=0.26-0.75%
water absorption rate of polysulfone (PSU)=0.30%
water absorption rate of polyamide imide (PAI)=0.33%
water absorption rate of polyamide (PA)=0.4-1.6%

### (7) Weight (Specific Gravity; Density)

The inventor has not found any literature which studies about the tray in view of the specific gravity.

It is as a matter of course that, upon transportation, etc., “lightness” is important. A light tray can be handled with ease. The transportation cost can be saved. From this point of view, “specific gravity ≤1.1” was preferred.

The resin composition containing PAA was light in weight in comparison with the resin composition containing CP, etc. The tray made of the resin composition containing PAA was light in weight by, for example, about 6-27%, in comparison with the resin composition containing CP.

The specific gravity of resin is as follows.
specific gravity of PAA=1.02-1.05
specific gravity of CP=2.20-2.26
specific gravity of CF=1.72-1.91
specific gravity of CNT=1.3-2.0
specific gravity of PPE=1.04-1.09
specific gravity of PP=0.90-0.91
specific gravity of PS=1.04-1.09
specific gravity of ABS=1.075-1.10
specific gravity of SAN=1.08-1.10
specific gravity of PMMA=1.17-1.20
specific gravity of PC=1.20
specific gravity of PAR=1.17-1.21
specific gravity of PA=1.08-1.15
specific gravity of PSU=1.24-1.25
specific gravity of PEI=1.27
specific gravity of PET=1.29-1.40
specific gravity of PEEK=1.30-1.32
specific gravity of PBT=1.30-1.38
specific gravity of PPS=1.34-1.35
specific gravity of PES=1.37-1.46
specific gravity of LCP=1.40
specific gravity of POM=1.42
specific gravity of PAI=1.42

Based on the above-mentioned knowledge, the present invention was achieved.

The present invention is directed to a resin composition containing a A resin, a B resin, a C resin, and a polymeric antistatic agent:
wherein the A resin is a polyphenylene ether-based resin;
wherein the B resin is a styrene-based resin;
wherein the C resin is one or more resin selected from the group consisting of a carbonate-based resin, an acrylic-based resin, an amide-based resin, a butylene terephthalate-based resin, and an ethylene terephthalate-based resin;
wherein the polymeric antistatic agent is 5-30 pts.mass to the A resin of 100 pts.mass;
wherein the B resin is 5-40 pts.mass to the A resin of 100 pts.mass; and
wherein the C resin is 30-240 pts.mass to the B resin of 100 pts.mass.

The present invention is directed to the resin composition, wherein the B resin is, preferably, one or more resin selected from the group consisting of a styrene-acrylonitrile copolymer, a styrene-butadiene copolymer, a styrene-acrylonitrile-butadiene copolymer, an ethylvinylbenzene-divinylbenzene copolymer, an acrylonitrile-styrene-chlorinated ethylene copolymer, an acrylonitrile-styrene-ethylene-propylene-diene copolymer, a polystyrene, a poly chlorostyrene, a poly(α-methyl styrene), and a rubber-modified polystyrene. The present invention is directed to the resin composition, wherein the B resin is, more preferably, one or more resin selected from the group consisting of a styrene-acrylonitrile copolymer, a styrene-butadiene copolymer, a styrene-acrylonitrile-butadiene copolymer, and a polystyrene. The present invention is directed to the resin composition, wherein the B resin is, further preferably, a styrene copolymer.

The present invention is directed to the resin composition, wherein the C resin is, preferably, one or more resin selected from the group consisting of a polycarbonate, a poly(methyl methacrylate), a polyamide, a polybutylene terephthalate, and a polyethylene terephthalate.

The present invention is directed to the resin composition, wherein the polymer type antistatic agent is, preferably, a polyether type antistatic agent. The present invention is directed to the resin composition, wherein the polymer type antistatic agent has, preferably, a number average molecular weight of 500 or greater.

The present invention is directed to the resin composition, wherein the polymeric antistatic agent is, preferably, 10-25 pts.mass to the A resin of 100 pts.mass.

The present invention is directed to the resin composition, wherein the A resin is, preferably, a homopolymer or a copolymer of a polymer which is expressed by the following General Equation [I].

The present invention is directed to the resin composition, wherein, preferably, the resin composition further contains compatibilizer.

The present invention is directed to the resin composition, wherein the compatibilizer is, preferably, a reactive compatibilizer.

The present invention is directed to the resin composition, wherein the compatibilizer is, preferably, 1-20 pts.mass to the A resin of 100 pts.mass.

The present invention is directed to the resin composition, wherein, preferably, the resin composition is substantially free from a carbon black, a carbon fiber, a carbon nanotube, metal powder, a metal fiber, and a surfactant having an antistatic function.

The present invention is directed to the resin composition, wherein the resin composition has, preferably, a water absorption rate of 0.8% or lower.

The present invention is directed to the resin composition, wherein the resin composition has, preferably, a HDT of 135° C. or higher.

The present invention is directed to the resin composition, wherein the resin composition has a surface electrical resistance value of 1.0×10¹²Ω or smaller.

The present invention is directed to the resin composition, wherein the resin composition has, preferably, a specific gravity of 1.0-1.1.

The present invention is directed to the resin composition, wherein, preferably, the resin composition can be subjected to kneading and molding processing under a temperature of 290° C. or lower.

The present invention is directed to a molded body made of the resin composition.

The present invention is directed to a tray for accommodating electronic products made of the resin composition.

### Advantageous Effect of Invention

The resin composition according to the present invention was suitable as a constituting material for a tray for accommodating the electronic products. The resin composition could be subjected to kneading and molding processing under a temperature of, for example, 290° C. or lower. The tray had a HDT of, for example, 135° C. or higher. The tray had a water absorption rate of, for example, 0.8% or lower. The tray had a surface electrical resistance value of, for example, 1.0×10¹²Ω or smaller. Because the resin composition is substantially free from a black antistatic agent such as CP, a problem (e.g., contamination) caused by the CP, etc., was solved. The tray having high cleanability could be obtained. The tray had a specific gravity of, for example, 1.0-1.1. It was lighter than a resin composition containing CP by about 6-27%. Because it is substantially free from the black antistatic agent such as CP, the tray was colorful. Upon storage, etc., of the electronic products, the electronic products could be accommodated in (color discriminable) trays having desired colors according to kinds of the electronic products. This achieves an easy classification. Therefore, in production process and production management of the electronic products, the electronic products could be discriminated with ease. That is, an easy handling can be realized.

### BRIEF DESCRIPTION OF DRAWINGS

FIG. 1 is a perspective view showing a state where a plurality of trays (containers) is stacked.

FIG. 2 is a cross section taken along the line I-I of FIG. 1.

FIG. 3 is a plan view of a tray (container) different from the trays of FIG. 1.

### DESCRIPTION OF EMBODIMENTS

The first invention is a resin composition. The resin composition contains a A resin, a B resin, a C resin, and a polymeric antistatic agent. The A resin is a polyphenylene ether-based resin. The B resin is a styrene-based resin. The C resin is one or more resin selected from the group consisting of a carbonate-based resin, an acrylic-based resin, an amide-based resin, a butylene terephthalate-based resin, and an ethylene terephthalate-based resin. The polymeric antistatic agent is 5-30 pts.mass to the A resin of 100 pts.mass. Preferably, it was 10 pts.mass or greater. More preferably, it was 13 pts.mass or greater. Further preferably, it was 15 pts.mass or greater. Preferably, it was 25 pts.mass or lesser. More preferably, it was 20 pts.mass or lesser. The B resin is 5-40 pts.mass to the A resin of 100 pts.mass. Preferably, it was 10 pts.mass or greater. More preferably, it was 15 pts.mass or greater. Preferably, it was 35 pts.mass or lesser. More preferably, it was 30 pts.mass or lesser. The C resin is 30-240 pts.mass to the B resin of 100 pts.mass. Preferably, it was 50 pts.mass or greater. More preferably, it was 60 pts.mass or greater. Preferably, it was 220 pts.mass or lesser. More preferably, it was 210 pts.mass or lesser.

The A resin was, preferably, a resin expressed by the following General Equation [I].

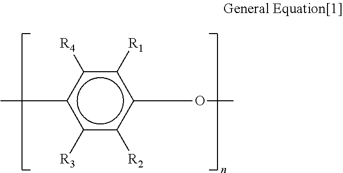

(In General Equation [I], R₁, R₂, R₃, and R₄ are a hydrogen atom, a halogen atom, a hydrocarbon group (e.g., alkyl group), a hydrocarbon-oxy group (e.g., alkoxy group), and a halogenated hydrocarbon group (e.g., halogenated alkyl group) or a halogenated hydrocarbon-oxy group (e.g., halogenated alkoxy group) having at least 2 carbon atoms between a halogen atom and a phenyl ring. For example, they are a monovalent substitution group selected from the one free from a tertiary α-carbon. R₁, R₂, R₃, and R₄ may be the same or may be different from each other. “n” is a positive integer showing a degree of polymerization. Preferably, it is an integer more than 20. More preferably, it is an integer more than 50.)

The polyphenylene ether-based resin may be a homopolymer or copolymer of the polymer expressed by General Equation [I]. In a preferable example, the R₁ and the R₂ are an alkyl group (the number of carbon atoms of 1-4). The R₁ and the R₄ are a hydrogen atom or an alkyl group (the number of carbon atoms of 1-4). As examples, poly (2,6-dimethyl-1,4-phenylene) ether, poly (2,6-diethyl-1,4-phenylene) ether, poly (2,6-dipropyl-1,4-phenylene) ether, poly (2,6-dilauryl-1,4-phenylene) ether, poly (2,6-diphenyl-1,4-phenylene) ether, poly (2,6-dimethoxy-1,4-phenylene) ether, poly (2,6-diethoxy-1,4-phenylene) ether, poly (2,6-dichlor-1,4-phenylene) ether, poly (2,6-dibenzyl-1,4-phenylene) ether, poly (2,6-dibromo-1, 4-phenylene) ether, poly (2-methyl-6-ethyl-1,4-phenylene) ether, poly (2-methyl-6-propyl-1,4-phenylene) ether, poly (2-methyl-6-phenyl-1,4-phenylene) ether, poly (2-ethyl-6-propyl-1,4-phenylene) ether, poly (2-ethyl-6-stearyloxy-1,4-phenylene) ether, poly (2-methoxy-6-ethoxy-1,4-phenylene) ether, poly (2-ethoxy-1,4-phenylene) ether, poly (2-chloro-1,4-phenylene) ether, etc., are shown. As the polyphenylene ether copolymer, a copolymer partially containing an alkyl tri-substituted phenol (e.g., 2,3,6-trimethylphenol) in a repeating unit of the polyphenylene ether is exemplified. It may be a copolymer obtained by grafting a styrene series compound onto the polyphenylene ether-based resin. As the styrene series compound, styrene, α-methylstyrene, vinyltoluene, and chlorostyrene are exemplified. It may be a copolymer composed of 2,6-dimethylphenol and 2,3,6-trimethylphenol. It may be the polyphenylene ether-based resin disclosed in JP1989-156A, JP1992-246461A, JP1995-228765A, JP 2010-229348A, etc.

A purpose of the present invention could not be achieved when the resin was composed of only the polyphenylene ether-based resin. A resin to be used with the polyphenylene ether-based resin was studied. As a result, the resin to be used with the polyphenylene ether-based resin were the B resin (styrene-based resin) and the C resin (one or more resin selected from the group consisting of a carbonate-based resin, an acrylic-based resin, an amide-based resin, a butylene terephthalate-based resin, and an ethylene terephthalate-based resin).

The B resin (styrene-based resin) was, preferably, one or more resin selected from the group consisting of a styrene-acrylonitrile copolymer, a styrene-butadiene copolymer, a styrene-acrylonitrile-butadiene copolymer, an ethylvinylbenzene-divinylbenzene copolymer, an acrylonitrile-styrene-chlorinated ethylene copolymer, an acrylonitrile-styrene-ethylene-propylene-diene copolymer, a polystyrene, a poly chlorostyrene, a poly (α-methyl styrene), and a rubber-modified polystyrene. The styrene-based resin may be either one of a monopolymer or copolymer. The copolymer was preferred. One or more resin selected from the group consisting of a styrene-acrylonitrile copolymer (AS), a styrene-butadiene copolymer (SB), and a styrene-acrylonitrile-butadiene copolymer (ABS) was more preferred.

The C resin was, preferably, one or more resin selected from the group consisting of a polycarbonate (PC), a polymethylmethacrylate (PMMA), a polyamide (PA), a poly butylene terephthalate (PBT), and a polyethylene terephthalate (PET).

Another resin (a resin other than the A resin, the B resin, and the C resin) can be used together. Here, it was preferred that an amount of the other resin other than the A resin, the B resin, and the C resin was one half or less of the amount of the C resin. It was more preferred that the amount of the other resin was one fourth or less of the amount of the C resin. In case of being beyond the afore-mentioned amount, a characteristic produced by a combination of (the A resin+the B resin+the C resin) was lost. This degrades the characteristics of the present invention. As a resin other than the A resin, the B resin, and the C resin, a thermoplastic resin was preferred.

The resin composition contains an antistatic agent. The antistatic agent is a polymer type antistatic agent (PAA). The polymer type antistatic agent was preferred because it bad relatively large molar weight (is relatively long), and which makes the antistatic agent hard to seep out from the resin composition. A meaning of the “polymer type” can be understood from the above description. A prepolymer is also included in the “polymer type”. For example, an antistatic agent of a molar weight (number average molecular weight: Mn) of 500 or greater was preferred (1000 or greater was more preferred). As the polymer type antistatic agent, for example, a polyether ester amide (e.g., polyether ester amide composed of polyoxyalkylene adduct of bisphenol A (see, JP1995-10989A)); a polyamide imide elastomer; a block polymer in which a bond unit of a polyolefin block and a hydrophilic polymer block has a 2-50 repeated structure (see, U.S. Pat. No. 6,552,131): a block copolymer of a polyolefine and a polyether: a graft polymer composed of a trunk polymer (polyamide) and a branch polymer (a block polymer of a polyalkyline ether and a polyester); a copolymer of an α-olefin, a maleic anhydride, and a polyalkylene allyl ether; a polymer composed of a polyethylene ether, an isocyanate, and a glycol: a copolymer of a multivalent carboxylic acid component, an organic diisocyanate, and a polyethylene glycol: a polyethylene oxide; a polyethylene oxide copolymer; a polyether ester: a polyether amide: a polyether ester amide; a partially crosslinked polyethylene oxide copolymer; an ionomer (e.g., a polymer having an alkali metal salt of a carboxylic acid, an alkali metal salt of a sulfonic acid, and a quaternary ammonium salt on a side chain); a graft polymer obtained by grafting a vinyl (or vinylidene) monomer (e.g., a styrene sulfonic acid sodium) onto a rubber copolymer of an alkylene oxide and a conjugated diene compound: a polymer forming an ionic derivative by nuclear substitution of a group such as a sulfonate group to a polyphenylene ether resin; a composition composed of a polyether ester imide and a carboxyl group-containing vinyl copolymer; a composition composed of a polyoxyalkylene group-containing alkyl amine, an alkyl sulfonic acid sodium, and an inorganic alkali metal salt; an acrylic ester-based elastomer; and a styrene-acrylate copolymer are exemplified. As a matter of course, the above-listed are mere examples. The polymer type antistatic agent (PAA) is well known. The polymer type antistatic agent (PAA) was, preferably, a polyether type antistatic agent.

The polymeric antistatic agent-containing resin composition had a HDT lower than the resin composition containing a conductive filler such as the CP. This did not cause any problem relating to the HDT of the resin composition of the present invention.

Preferably, the resin composition further contains a compatibilizer. Various types of compatibilizers are known. The compatibilizer is a compatibilizer for the A resin, the B resin, the C resin, and the polymer type antistatic agent. A preferred compatibilizer was a reactive compatibilizer. As the compatibilizer, a polar functional group-containing polystyrene reactive compatibilizer is exemplified. An oxazoline group-containing reactive polystyrene is exemplified. A hydrogenated styrene-based thermal plastic elastomer of styrene-butadiene copolymer (SEBS) is exemplified. A random copolymer resin of styrene/maleic anhydride (SMA) is exemplified. As a matter of course, the above-listed are mere examples.

The compatibilizer was, preferably, 1-20 pts.mass to the A resin of 100 pts.mass. It was, more preferably, 5 pts.mass or greater. It was, further preferably, 7 pts.mass or greater. It was, preferably, 15 pts.mass or lesser. It was, more preferably, 13 pts.mass or lesser.

The resin composition is, preferably, substantially free from CP, CF, CNT, MP, MF, and SAA. The resin composition containing a large amount of powder and fibers of the substances had problems contamination due to dropout, falling powder, and raising dust, and protrusion and breakage of fibers. SAA (surface active agent) tends to seep out from the resin composition. No such problems occur in the present invention. The resin composition is, preferably, substantially free from the antistatic agent (CP, CF, CNT, MP, and MF) of a color from dark gray to black. When containing a large amount of antistatic agent (e.g., CP, etc.) of a color from dark gray to black, a large problem arises. A small amount thereof will not raise a large problem. Here, “substantially free from” means “such a degree that a color because of the substance is not conspicuously seen in the resin composition”. In other words, if CP, CF, CNT, MP, and MF are contained up to a certain degree, the resin composition shows a brown or black color. This degrades an appearance. This makes specific gravity large. This causes dropout, falling powder, raising dust, and protrusion and breakage of fibers.

The resin composition does not contain a coloring material. Here, containing (addition, blending) of coloring material is not denied. For example, a content up to a degree that a color change of the resin composition by heating can be observed will be acceptable. For example, it can be guessed that the color change of the resin composition-made tray by heating shows a possible change of physical property (e.g., surface electrical resistance value) of the resin composition. This is because the color change of the resin composition refers to degradation (change in quality; modification) of the resin composition (specially, the resin). The degradation of the resin composition is caused due to, for example, oxidization (oxidization promoted by heating) of the resin composition. Based on such color change, continuous use or change of the tray can be decided. The heating of the resin composition and the subsequent prior research of a relationship between the color change and the surface electrical resistance value shows a timing at which the surface electrical resistance value exceeds a certain threshold when the color changed to a certain color (when the tray becomes the priory researched fixed color).

Preferably, the resin composition had a HDT of 135° C. or higher. More preferably, it was 140° C. or higher. Further preferably, it was 150° C. or higher. There is no specific limit in upper value.

Preferably, the resin composition had a surface electrical resistance value of 1.0×10¹²Ω or lesser. More preferably, it was 1.0×10¹¹Ω or lesser. Further preferably, it was 1.0×10¹⁰Ω or lesser. For example, it was 1.0×10⁸Ω or greater.

Preferably, the resin composition had a water absorption rate of 0.8% or lower. More preferably, the water absorption rate thereof was 0.63% or lower. Further preferably, the water absorption rate thereof was 0.55% or lower. Specially preferably, the water absorption rate thereof was 0.47% or lower.

Preferably, the resin composition had a specific gravity of 1.0-1.1. More preferably, it was 1.01 or greater. Further preferably, it was 1.02 or greater. Preferably, it was below 1.1. More preferably, it was 1.09 or lesser.

Preferably, the resin composition could be subjected to kneading and molding processing of resin compound under a temperature of 290° C. or lower.

There was a close relationship between the physical property and contents of the resin composition of the present invention.

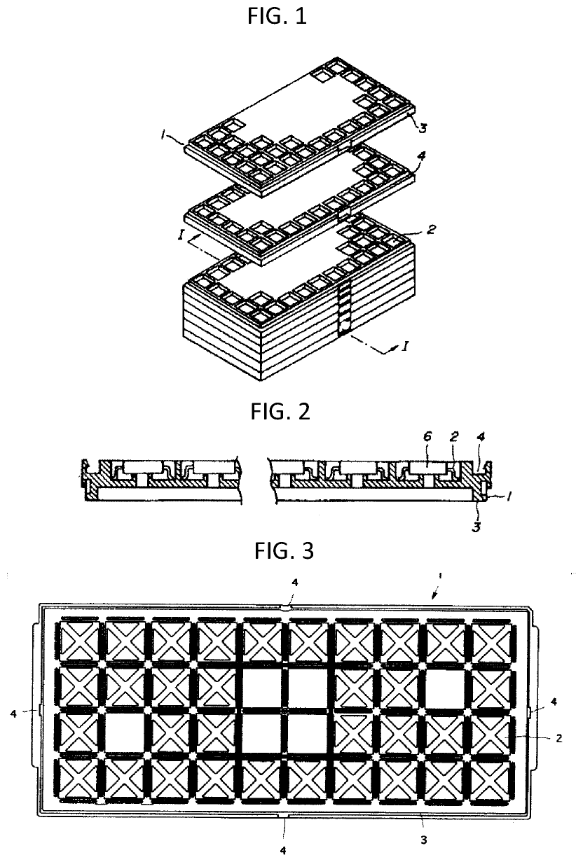

The second invention is directed to a molded body. The molded body is made of the resin composition. The molded body is, for example, a tray. It is, for example, a tray for ICs. It is, for example, a tray for accommodating semiconductor elements (products). It is, for example, a tray for accommodating electronic products. The tray has housing spaces for housing, for example, electronic products (Electronic parts are also included in the electronic products). There is a plurality of (two or more) housing spaces. The tray has a shape (structure) as shown in, for example, FIG. 1 and FIG. 3. As a matter of course, the shape (structure) is not limited thereto.

Preferably, the tray has been subjected to anneal processing. By heating, a residual stress of the tray was removed. Deformation of the tray can be prevented. A shape and a dimension are stable. In a case where the resin composition according to the present invention is used as a material of the tray, the tray was excellent in shape and stabilization in dimension. The problems disclosed in PATENT LITERATURE 4 was solved. That is, “The PPE resin composition containing much polyalkylen oxide (antistatic agent) has problems in deterioration of strength, delamination, and impact resistant strength of the molded products.” was solved.

The tray is used upon transporting the electronic products (alternatively, upon characteristic inspection of the products, upon mounting of the products, or upon storage of the products). The tray is used in, for example, a heating atmosphere. It is used in, for example, an air atmosphere (in an oxidizing atmosphere).

Hereinafter, specific examples are described. The present invention is not limited only to the following examples. In so far as the characteristics of the present invention is not largely degraded, various modifications and applications are also embraced within the scope of the present invention.

### Examples and Reference Examples

### <Noncrystalline Thermoplastic Resin>

PPE (lupiace PX-100F (polyphenylene ether made by Mitsubishi Engineering-Plastics Corporation); HDT=191° C.)
SAN (KIBISAN PN-117 (acrylonitrile-styrene copolymer made by CHIMEI Corporation); HDT=89° C.)
PC (lupilon S2000R (polycarbonate made by Mitsubishi Engineering-Plastics Corporation); HDT=130° C.)
PS (Toyo Styrene GP MWIC (polystyrene made by TOYO-STYRENE CO., LTD.); HDT=72° C.)
ABS (POLYLAC PA-757 (acrylonitrile-butadiene-styrene copolymer made by CHIMEI Corporation); HDT=83° C.)
PMMA (DELPET 60N (polymethylmethacry late made by Asahi Kasei Corporation); HDT=91° C.)
PAR (U Polymer U-100 (polyallylate made by UNITIKA LTD.); HDT=177° C.)
PSU (Udel P-1700 (polysulfone made by SOLVAY S.A.); HDT=174° C.)
PEI (ULTEM PEI (polyether imide made by KUREHA EXTRON CO., LTD.); HDT=200° C.)
PAI (VYLOMAX HR-11NN (polyamide imide made by TOYOBO CO., LTD.); HDT=278° C.)
PES (SUMIKAEXCEL PES3600G (polyether sulfone made by Sumitomo Chemical Co., Ltd.); HDT=203° C.)

### <Crystalline Thermoplastic Resin>

PP (SunAllomer PM600A (polypropylene made by SunAllomer Ltd.); HDT=103° C. (0.45 MPa))
POM (TENAC 7050 (polyacetal made by Asahi Kasei Corporation); HDT=105° C.)
PA (Hyplon 70FN (polyamide made by Arkema S.A.); HDT=65° C.)
PET (VYLOPET EMC-500 (polyethylene terephthalate made by TOYOBO CO., LTD.); HDT=85° C.)
PBT (TORAYCON 1401× 06 (polybutylene terephthalate made by Toray Industries, Inc.); HDT=70° C.)
PPS (FORTRON KPS (polyphenylene sulfide made by KUREHA CORPORATION); HDT=110° C.)
PEEK (VICTREX PEEK Polymer 450G (polyether ether ketone made by Victrex plc.); HDT=156° C.)
LCP (Vectra A950 (liquid crystal polymer made by Celanese Corp.); HDT=190° C.)

### <Thermosetting Resin>

EP (jER1004 (solid epoxy resin made by Mitsubishi Chemical Corporation); HDT=80° C.)
PF (SUMILITERESIN PR-HF-6 (straight phenol novolac resin made by Sumitomo Bakelite Co., Ltd.); HDT=120° C.)
UP (U-pica 8510 (unsaturated polyester made by Japan U-pica.co.ltd.); HDT=90° C.)

### <Curing Agent; Crosslinking Agent>

PPF GjER 170 (powder phenolics made by Mitsubishi Chemical Corporation); curing agent of EP)
HMTA (hexamethylenetetramine (made by FUJIFILM Wako Pure Chemical Corporation)); curing agent of PF)
DAPP (DAISO DAP-A (diallyl phthalate prepolymer made by OSAKA SODA CO., LTD.; crosslinking agent of UP)
DCPO (PERCUMYL D (dicumyl peroxide made by NOF CORPORATION); curing agent between UP and DAPP)

### <Filling Material>

SiO: (ADMAFUSE FE9 (amorphous silica particles made by Admatechs); filling material of EP)
CaCO; (WHITON-H (Calcium Carbonate made by Toyo Fine Chemical Kaisha, Ltd.); filling material of PF)
Al(OH)₃ (Hydrargilite H32 (aluminium hydroxide made by Resonac Holdings Corporation); filling material of UP)
   Particles such as SiO₂, CaCO₃, and Al(OH)₃ are inorganic filling materials.

### <Mold Releasing Agent>

ZNS (ZINC STEARATE GP (metal soap made by NOF CORPORATION); mold releasing agent)

### <Antistatic Agent>

PELECTRON AS (polymeric antistatic agent made by Sanyo Chemical Industries, Ltd. (polyether type antistatic agent)); HDT=45° C.
PELECTRON HS (polymeric antistatic agent made by Sanyo Chemical Industries, Ltd. (polyether type antistatic agent)); HDT=45° C.
CP (KETJENBLACK EC300J (carbon black made by LION SPECIALTY CHEMICALS CO., LTD.)
CF (TORAY CA CUT FIBER T010-003 (carbon fiber made by Toray Industries, Inc.))
CNT (MWNT (carbon nanotube made by Meijo Nano Carbon. Co., Ltd))

### <Surface Active Agent>

SAA (CHEMISTAT (non-ionic surface active agent made by Sanyo Chemical Industries, Ltd.)

### <Compatibilizer>

Compatibilizer (EPOCROS PRS-1005 (oxazoline group-containing reactive polystyrene compatibilizer made by NIPPON SHOKUBAI CO., LTD.))

### Blend Examples

A blend ratio of the above-described components is as follows. The unit of values in parenthesis is pts.mass.
No. 1: PPE (100)+SAN (15)+PC (13)+PELECTRON AS (15)
No. 2: PPE (100)+SAN (15)+PC (13)+PELECTRON AS (15)+EPOCROS PRS-1005 (10)
No. 3: PPE (100)+SAN (15)+PMMA (13)+PELECTRON AS (15)
No. 4: PPE (100)+SAN (15)+PMMA (13)+PELECTRON AS (15)+EPOCROS PRS-1005 (10)
No. 5: PPE (100)+SAN (15)+PBT (13)+PELECTRON AS (15)
No. 6: PPE (100)+SAN (15)+PBT (13)+PELECTRON AS (15)+EPOCROS PRS-1005 (10)
No. 7: PPE (100)+SAN (15)+PET (13)+PELECTRON AS (15)
No. 8: PPE (100)+SAN (15)+PET (13)+PELECTRON AS (15)+EPOCROS PRS-1005 (10)
No. 9: PPE (100)+SAN (15)+PA (13)+PELECTRON AS (15)
No. 10: PPE (100)+SAN (15)+PA (13)+PELECTRON AS (15)+EPOCROS PRS-1005 (10)
No. 11: PPE (100)+SAN (7)+PC (3)+PELECTRON AS (15)+EPOCROS PRS-1005 (10)
No. 12: PPE (100)+SAN (7)+PC (10)+PELECTRON AS (15)+EPOCROS PRS-1005 (10)
No. 13: PPE (100)+SAN (40)+PC (15)+PELECTRON AS (15)+EPOCROS PRS-1005 (10)
No. 14: PPE (100)+SAN (40)+PC (90)+PELECTRON AS (15)+EPOCROS PRS-1005 (10)
No. 15: PPE (100)+SAN (15)+PC (8)+PMMA (5)+PELECTRON AS (15)+EPOCROS PRS-1005 (10)
No. 16: PPE (100)+SAN (15)+PC (8)+PET (5)+PELECTRON AS (15)+EPOCROS PRS-1005 (10)
No. 17: PPE (100)+SAN (15)+PC (8)+PA (5)+PELECTRON AS (15)+EPOCROS PRS-1005 (10)
No. 18: PPE (100)+SAN (15)+PBT (8)+PET (5)+PELECTRON AS (15)+EPOCROS PRS-1005 (10)
No. 19: PPE (100)+SAN (15)+PBT (8)+PA (5)+PELECTRON AS (15)+EPOCROS PRS-1005 (10)
No. 20: PPE (100)+SAN (15)+PET (8)+PA (5)+PELECTRON AS (15)+EPOCROS PRS-1005 (10)
No. 21: PPE (100)+SAN (15)+PMMA (8)+PA (5)+PELECTRON AS (15)+EPOCROS PRS-1005 (10)
No. 22: PPE (100)+PELECTRON AS (15)
No. 23: PPE (100)+PELECTRON AS (15)+EPOCROS PRS-1005 (10)
No. 24: PPE (100)+SAN (15)+PELECTRON AS (15)
No. 25: PPE (100)+SAN (15)+PELECTRON AS (15)+EPOCROS PRS-1005 (10)
No. 26: PPE (100)+SAN (15)+PSU (13)+PELECTRON AS (15)
No. 27: PPE (100)+SAN (15)+PSU (13)+PELECTRON AS (15)+EPOCROS PRS-1005 (10)
No. 28: PPE (100)+SAN (15)+PEI (13)+PELECTRON AS (15)
No. 29: PPE (100)+SAN (15)+PEI (13)+PELECTRON AS (15)+EPOCROS PRS-1005 (10)
No. 30: PPE (100)+SAN (15)+PES (13)+PELECTRON AS (15)
No. 31: PPE (100)+SAN (15)+PES (13)+PELECTRON AS (15)+EPOCROS PRS-1005 (10)
No. 32: PPE (100)+SAN (15)+PAR (13)+PELECTRON AS (15)
No. 33: PPE (100)+SAN (15)+PAR (13)+PELECTRON AS (15)+EPOCROS PRS-1005 (10)
No. 34: PPE (100)+SAN (15)+POM (13)+PELECTRON AS (15)
No. 35: PPE (100)+SAN (15)+POM (13)+PELECTRON AS (15)+EPOCROS PRS-1005 (10)
No. 36: PPE (100)+SAN (4)+PC (1)+PELECTRON AS (15)+EPOCROS PRS-1005 (10)
No. 37: PPE (100)+SAN (4)+PC (7)+PELECTRON AS (15)+EPOCROS PRS-1005 (10)
No. 38: PPE (100)+SAN (45)+PC (10)+PELECTRON AS (15)+EPOCROS PRS-1005 (10)
No. 39: PPE (100)+SAN (45)+PC (110)+PELECTRON AS (15)+EPOCROS PRS-1005 (10)
No. 40: PPE (100)+SAN (15)+PC (13)+PELECTRON AS (3)+EPOCROS PRS-1005 (10)
No. 41: PPE (100)+SAN (15)+PC (13)+PELECTRON AS (35)+EPOCROS PRS-1005 (10)
No. 42: PPE (100)+SAN (15)+PC (13)+PELECTRON AS (3)+EPOCROS PRS-1005 (25)
No. 43: PPE (100)+SAN (15)+PC (13)+PELECTRON AS (35)+EPOCROS PRS-1005 (25)
No. 44: PPE (100)+PS (20)+CP (10)
No. 45: PPE (100)+PS (20)+CF (10)
No. 46: PPE (100)+PS (20)+CNT (5)
No. 47: PPE (100)+PS (20)+SAA (10)
No. 48: PC (100)+SAN (15)+PELECTRON AS (15)
No. 49: PS (100)+SAN (15)+PELECTRON HS (8)
No. 50: ABS (100)+SAN (15)+PELECTRON AS (15)
No. 51: SAN (115)+PELECTRON AS (15)
No. 52: PMMA (100)+SAN (15)+PELECTRON AS (15)
No. 53: PAR (100)+SAN (15)+PELECTRON AS (15)
No. 54: PSU (100)+SAN (15)+PELECTRON AS (15)
No. 55: PEI (100)+SAN (15)+PELECTRON AS (15)
No. 56: PAI (100)+SAN (15)+PELECTRON AS (15)
No. 57: PES (100)+SAN (15)+PELECTRON AS (15)
No. 58: PP (100)+SAN (15)+PELECTRON HS (8)
No. 59: POM (100)+SAN (15)+PELECTRON AS (15)
No. 60: PBT (100)+SAN (15)+PELECTRON AS (15)
No. 61: PPS (100)+SAN (15)+PELECTRON AS (15)
No. 62: PEEK (100)+SAN (15)+PELECTRON AS (15)
No. 63: LCP (100)+SAN (15)+PELECTRON AS (15)
No. 64: EP (100)+curing agent PPF (25)+CP (10)+SiO₂ (150)+mold releasing agent ZNS (5)
No. 65: PF (100)+curing agent HMTA (25)+CP (10)+CaCO₃ (150)+mold releasing agent ZNS (5)
No. 66: UP (100)+crosslinking agent DAPP (25)+curing agent DCPO (3)+CP (10)+Al(OH)₃ (150)+mold releasing agent ZNS (5)

### <No. 1-63>

A composition having the above-mentioned blend ratio was agitated and mixed (for 3 minutes at a speed of 800 rpm) by a FM75B (Henschel Mixer manufactured by MITSUI MIIKE MACHINERY CO., LTD.). The mixture was subjected to melt kneading by a TEX44αIII (vent type twin-screw extruder manufactured by The Japan Steel Works, Ltd.; at a speed of 200 rpm; at a temperature of 280° C.). An extrusion strand was cooled and cut. Pellets could be obtained. The pellets were supplied to Si-III KC-BRO (injection molding machine manufactured by TOYO MACHINERY & METAL CO., LTD.). Melting injection molding (cylinder temperature=290° C.; mold temperature=90° C.) was performed. A substrate (75 mm square×3 mm thickness) could be obtained.

### <No. 64-66>

A composition having the above-mentioned blend ratio was agitated and mixed by the FM75B (at a temperature of 95° C.; for 7 minutes; at a speed of 800 rpm). The mixture was subjected to melt kneading by a TEX44a (vent type twin-screw extruder for thermosetting resin manufactured by THE JAPAN STEEL WORKS. LTD.; at a speed of 100 rpm:at a temperature of 90° C.). The kneaded mixture extruded from a die was subjected to hot cut. Pellets could be obtained. The pellets were supplied to M-100ADS-TS (injection molding machine for thermosetting resin manufactured by THE JAPAN STEEL WORKS. LTD.). Melting injection molding (cylinder temperature=90° C.; mold temperature=160° C.) was performed. A substrate (75 mm square×3 mm thickness) could be obtained.

### [Evaluation Point: Evaluation Method]

<Resin Compound Kneading Performance with Twin-Screw Extruder>
⊚: Excellent in kneading performance. Excellent in strand uniformity. Excellent in pellet cut.
◯: Good in kneading performance. Good in strand uniformity. Good in pellet cut.
Δ: Somewhat bad in kneading performance. Somewhat bad in strand uniformity. Somewhat bad in pellet cut.
x: Bad in kneading performance. Bad in strand uniformity. Bad in pellet cut.

### <Injection Moldability; Appearance>

⊚: Excellent in moldability. Excellent in appearance of molded substrate.
◯: Good in moldability. Good in appearance of molded substrate.
Δ: Somewhat bad in moldability. Somewhat bad in appearance of molded substrate (small swell; a little delamination).
x: Bad in moldability. Bad in appearance of molded substrate (large swell; large delamination).

### <Pencil Hardness (Blackness): Contamination>

A corner of the substrate was pressed against (0.5 kg weight) a copy paper (A4 size paper manufactured by KOKUYO Co., Ltd.) and then pulled. A line was drawn by this performance. This means that contamination tends to occur. The blackness is shown by a pencil hardness (blackness) from 10H to 10B. A case where no line was drawn is shown by ND.
⊚: ND
Δ: 10H-H
x: F-10B

### <Cleanability>

By the injection molding, an IC tray having a shape standardized by the JEDEC was molded. The molded products (thin plate-shaped molded products of “CV8710MV” for epoxy resin BGA manufactured by Panasonic Corporation) were mounted in a storage area of the IC tray. Three IC trays are stacked to be bundled by a band. Twenty such sets were put in a corrugated board box.

A vibration testing machine (“VIBRATOR GENELATION” FT-10K/80 manufactured by EMIC CORPORATION) was used to perform a test by JIS Z0238 “Packed Baggage Vibration Test Method” at level II.
⊚: Cleanability was maintained.
x: There was no cleanability (Contamination phenomenon (falling powder, protrusion and breakage of fibers, and bleed out) occurred)).

### <Heat Distortion Temperature (HDT)>

A measuring device (3M-2 type (manufactured by Toyo Seiki Seisaku-sho, Ltd.)) was used. Under the conditions (ISO75 (1.82 MPa)), the HDT was measured.
⊚: 150° C. or higher
∘: 135° C. or higher to less than 150° C.
x: less than 135° C.

### <Surface Electrical Resistance Value>

A measuring device (Simco Ion surface resistance measurement device (Model ST-4); IEC measurement electrode kit for surface resistance measurement device (manufactured by SIMCO JAPAN)) was used. Under the conditions (IEC60093), the surface electric resistance value was measured.
⊚: less than 1.0×10¹¹Ω
◯: 1.0×10¹¹-1.0×10¹²Ω
x: over 1.0×10¹²Ω

### <Water Absorption Rate>

A water absorption rate of the substrate (75 mm square×3 mm thickness) was measured (Conditions (ISO62)).
⊚: 0.47% or lower
◯: 0.48-0.8%
x: over 0.8%

### <Specific Gravity>

A specific gravity of the substrate (75 mm square×3 mm thickness) was measured (Conditions (ISO1183)).
⊚: 1.0-1.1
x: over 1.1

### <Discoloration Recognition>

An ETAC-HS320) (hot air drying machine manufactured by Kusumoto Chemicals, Ltd.) was used to perform hot air drying. The hot air drying was performed under conditions at a temperature of 135° C. (hot air blowing temperature) for 500 hours, or at a temperature of 150° C. (hot air blowing temperature) for 250 hours.

### <Discoloration Recognition: Recognizable/Unrecognizable at 135° C. for 500 Hours>

Whether or not the discoloration can be visually recognized.
⊚: “500” shows that the discoloration can be recognized even at a time at which 500 hours has passed from the start of heating.
◯: “400” shows that the discoloration can be recognized by a time at which 400 hours has passed from the start of heating.
Δ: “Number (N) less than 400” shows that the discoloration can be recognized by N hours has passed from the start of heating.
x: “0” shows that no discoloration can be recognized at a time at which the heating starts.

### <Discoloration Recognition: Recognizable/Unrecognizable at 150° C. for 250 Hours>

Whether or not the discoloration can be visually recognized.
⊚: “250” shows that the discoloration can be recognized even at a time at which 250 hours has passed from the start of heating.
◯: “200” shows that the discoloration can be recognized by a time at which 200 hours has passed from the start of heating.
Δ: “Number (N) less than 200” shows that the discoloration can be recognized by N hours has passed from the start of heating.
x: “0” shows that no discoloration can be recognized at a time at which the heating starts.

Characteristics of the molded substrate was researched. The result is shown in the following Tables 1, 2, and 3.

| | [symbol] | | | | [symbol] | | | | | |
|---|---|---|---|---|---|---|---|---|---|---|
| No. | [symbol] | [symbol] | [symbol] | [symbol] | [symbol] | [symbol] | [symbol] | [symbol] | [symbol] | [symbol] |
| 1 | ⊚ | ⊚ | [symbol] | ⊚ | [symbol] | [symbol] | [symbol] | [symbol] | [symbol] | [symbol] |
| | | | ⊚ | | ⊚ | ⊚ | ⊚ | ⊚ | ⊚ | ⊚ |
| 2 | ⊚ | ⊚ | [symbol] | ⊚ | [symbol] | [symbol] | [symbol] | [symbol] | [symbol] | [symbol] |
| | | | ⊚ | | ⊚ | ⊚ | ◯ | ⊚ | ⊚ | ⊚ |
| 3 | ⊚ | ⊚ | [symbol] | ⊚ | [symbol] | [symbol] | [symbol] | [symbol] | [symbol] | [symbol] |
| | | | ⊚ | | ⊚ | ⊚ | ⊚ | ⊚ | ⊚ | ⊚ |
| 4 | ⊚ | ⊚ | [symbol] | ⊚ | [symbol] | [symbol] | [symbol] | [symbol] | [symbol] | [symbol] |
| | | | ⊚ | | ◯ | ⊚ | ◯ | ⊚ | ⊚ | ⊚ |
| 5 | ⊚ | ⊚ | [symbol] | ⊚ | [symbol] | [symbol] | [symbol] | [symbol] | [symbol] | [symbol] |
| | | | ⊚ | | ⊚ | ⊚ | ⊚ | ⊚ | ⊚ | ⊚ |
| 6 | ⊚ | ⊚ | [symbol] | ⊚ | [symbol] | [symbol] | [symbol] | [symbol] | [symbol] | [symbol] |
| | | | ⊚ | | ◯ | ⊚ | ◯ | ⊚ | ⊚ | ⊚ |
| 7 | ◯ | ◯ | [symbol] | ⊚ | [symbol] | [symbol] | [symbol] | [symbol] | [symbol] | [symbol] |
| | | | ⊚ | | ⊚ | ⊚ | ⊚ | ⊚ | ⊚ | ⊚ |
| 8 | ◯ | ◯ | [symbol] | ⊚ | [symbol] | [symbol] | [symbol] | [symbol] | [symbol] | [symbol] |
| | | | ⊚ | | ◯ | ⊚ | ◯ | ⊚ | ⊚ | ⊚ |
| 9 | ⊚ | ⊚ | [symbol] | ⊚ | [symbol] | [symbol] | [symbol] | [symbol] | [symbol] | [symbol] |
| | | | ⊚ | | ⊚ | ⊚ | ⊚ | ⊚ | ⊚ | ⊚ |
| 10 | ⊚ | ⊚ | [symbol] | ⊚ | [symbol] | [symbol] | [symbol] | [symbol] | [symbol] | [symbol] |
| | | | ⊚ | | ◯ | ⊚ | ◯ | ⊚ | ⊚ | ⊚ |
| 11 | ⊚ | ⊚ | [symbol] | ⊚ | [symbol] | [symbol] | [symbol] | [symbol] | [symbol] | [symbol] |
| | | | ⊚ | | ⊚ | ⊚ | ◯ | ⊚ | ⊚ | ⊚ |
| 12 | ⊚ | ⊚ | [symbol] | ⊚ | [symbol] | [symbol] | [symbol] | [symbol] | [symbol] | [symbol] |
| | | | ⊚ | | ⊚ | ⊚ | ◯ | ⊚ | ⊚ | ⊚ |
| 13 | ⊚ | ⊚ | [symbol] | ⊚ | [symbol] | [symbol] | [symbol] | [symbol] | [symbol] | [symbol] |
| | | | ⊚ | | ◯ | ⊚ | ◯ | ⊚ | ⊚ | ⊚ |
| 14 | ⊚ | ⊚ | [symbol] | ⊚ | [symbol] | [symbol] | [symbol] | [symbol] | [symbol] | [symbol] |
| | | | ⊚ | | ◯ | ◯ | ⊚ | ⊚ | ⊚ | ⊚ |
| 15 | ⊚ | ⊚ | [symbol] | ⊚ | [symbol] | [symbol] | [symbol] | [symbol] | [symbol] | [symbol] |
| | | | ⊚ | | ⊚ | ⊚ | ◯ | ⊚ | ⊚ | ⊚ |
| 16 | ⊚ | ⊚ | [symbol] | ⊚ | [symbol] | [symbol] | [symbol] | [symbol] | [symbol] | [symbol] |
| | | | ⊚ | | ⊚ | ⊚ | ◯ | ⊚ | ⊚ | ⊚ |
| 17 | ⊚ | ⊚ | [symbol] | ⊚ | [symbol] | [symbol] | [symbol] | [symbol] | [symbol] | [symbol] |
| | | | ⊚ | | ⊚ | ⊚ | ◯ | ⊚ | ⊚ | ⊚ |
| 18 | ⊚ | ⊚ | [symbol] | ⊚ | [symbol] | [symbol] | [symbol] | [symbol] | [symbol] | [symbol] |
| | | | ⊚ | | ◯ | ⊚ | ◯ | ⊚ | ⊚ | ⊚ |
| 19 | ⊚ | ⊚ | [symbol] | ⊚ | [symbol] | [symbol] | [symbol] | [symbol] | [symbol] | [symbol] |
| | | | ⊚ | | ◯ | ⊚ | ◯ | ⊚ | ⊚ | ⊚ |
| 20 | ⊚ | ⊚ | [symbol] | ⊚ | [symbol] | [symbol] | [symbol] | [symbol] | [symbol] | [symbol] |
| | | | ⊚ | | ◯ | ⊚ | ◯ | ⊚ | ⊚ | ⊚ |
| 21 | ⊚ | ⊚ | [symbol] | ⊚ | [symbol] | [symbol] | [symbol] | [symbol] | [symbol] | [symbol] |
| | | | ⊚ | | ◯ | ⊚ | ◯ | ⊚ | ⊚ | ⊚ |

[symbol]

indicates data missing or illegible when filed

| | [symbol] | | | | [symbol] | | | | | |
|---|---|---|---|---|---|---|---|---|---|---|
| | [symbol] | [symbol] | [symbol] | [symbol] | [symbol] | [symbol] | [symbol] | [symbol] | [symbol] | [symbol] |
| 22 | Δ | Δ | [symbol] | ⊚ | [symbol] | [symbol] | [symbol] | [symbol] | [symbol] | [symbol] |
| | | | ⊚ | | ⊚ | ⊚ | ⊚ | ⊚ | ⊚ | ⊚ |
| 23 | Δ | Δ | [symbol] | ⊚ | [symbol] | [symbol] | [symbol] | [symbol] | [symbol] | [symbol] |
| | | | ⊚ | | ⊚ | ⊚ | ◯ | ⊚ | ⊚ | ⊚ |
| 24 | Δ | Δ | [symbol] | ⊚ | [symbol] | [symbol] | [symbol] | [symbol] | [symbol] | [symbol] |
| | | | ⊚ | | ⊚ | ⊚ | ⊚ | ⊚ | ⊚ | ⊚ |
| 25 | Δ | Δ | [symbol] | ⊚ | [symbol] | [symbol] | [symbol] | [symbol] | [symbol] | [symbol] |
| | | | ⊚ | | ⊚ | ⊚ | ◯ | ⊚ | ⊚ | ⊚ |
| 26 | Δ | Δ | [symbol] | ⊚ | [symbol] | [symbol] | [symbol] | [symbol] | [symbol] | [symbol] |
| | | | ⊚ | | ⊚ | ⊚ | ⊚ | ⊚ | ⊚ | ⊚ |
| 27 | Δ | Δ | [symbol] | ⊚ | [symbol] | [symbol] | [symbol] | [symbol] | [symbol] | [symbol] |
| | | | ⊚ | | ⊚ | ⊚ | | ⊚ | ⊚ | ⊚ |
| 28 | X | X | — | — | — | — | — | — | — | — |
| | | | — | | — | — | — | — | — | — |
| 29 | X | X | — | — | — | — | — | — | — | — |
| | | | — | | — | — | — | — | — | — |
| 30 | X | X | — | — | — | — | — | — | — | — |
| | | | — | | — | — | — | — | — | — |
| 31 | X | X | — | — | — | — | — | — | — | — |
| | | | — | | — | — | — | — | — | — |
| 32 | Δ | Δ | [symbol] | ⊚ | [symbol] | [symbol] | [symbol] | [symbol] | [symbol] | [symbol] |
| | | | ⊚ | | ⊚ | ⊚ | ⊚ | ⊚ | ⊚ | ⊚ |
| 33 | Δ | Δ | [symbol] | ⊚ | [symbol] | [symbol] | [symbol] | [symbol] | [symbol] | [symbol] |
| | | | ⊚ | | ⊚ | ◯ | ◯ | ⊚ | ⊚ | ⊚ |
| 34 | Δ | X | — | — | — | — | — | — | — | — |
| | | | — | | — | — | — | — | — | — |
| 35 | Δ | X | — | — | — | — | — | — | — | — |
| | | | — | | — | — | — | — | — | — |
| 36 | Δ | Δ | [symbol] | ⊚ | [symbol] | [symbol] | [symbol] | [symbol] | [symbol] | [symbol] |
| | | | ⊚ | | ⊚ | ⊚ | ◯ | ⊚ | ⊚ | ⊚ |
| 37 | Δ | Δ | [symbol] | ⊚ | [symbol] | [symbol] | [symbol] | [symbol] | [symbol] | [symbol] |
| | | | ⊚ | | ⊚ | ⊚ | ◯ | ⊚ | ⊚ | ⊚ |
| 38 | Δ | Δ | [symbol] | ⊚ | [symbol] | [symbol] | [symbol] | [symbol] | [symbol] | [symbol] |
| | | | ⊚ | | ◯ | ⊚ | ◯ | ⊚ | ⊚ | ⊚ |
| 39 | Δ | Δ | [symbol] | ⊚ | [symbol] | [symbol] | [symbol] | [symbol] | [symbol] | [symbol] |
| | | | ⊚ | | ◯ | ◯ | ⊚ | X | ⊚ | ⊚ |
| 40 | ◯ | ◯ | [symbol] | ⊚ | [symbol] | [symbol] | [symbol] | [symbol] | [symbol] | [symbol] |
| | | | ⊚ | | ⊚ | X | ⊚ | ⊚ | ⊚ | ⊚ |
| 41 | ◯ | Δ | [symbol] | ⊚ | [symbol] | [symbol] | [symbol] | [symbol] | [symbol] | [symbol] |
| | | | ⊚ | | ◯ | ⊚ | ◯ | ⊚ | ⊚ | ⊚ |
| 42 | ◯ | ◯ | [symbol] | ⊚ | [symbol] | [symbol] | [symbol] | [symbol] | [symbol] | [symbol] |
| | | | ⊚ | | ◯ | ◯ | ⊚ | ⊚ | ⊚ | ⊚ |
| 43 | ◯ | Δ | [symbol] | ⊚ | [symbol] | [symbol] | [symbol] | [symbol] | [symbol] | [symbol] |
| | | | ⊚ | | X | ⊚ | X | ⊚ | ⊚ | ⊚ |
| 44 | ◯ | ◯ | [symbol] | [symbol] | [symbol] | [symbol] | [symbol] | [symbol] | [symbol] | [symbol] |
| | | | X | X | ⊚ | ⊚ | ⊚ | X | X [symbol] | X [symbol] |
| 45 | ◯ | ◯ | [symbol] | [symbol] | [symbol] | [symbol] | [symbol] | [symbol] | [symbol] | [symbol] |
| | | | Δ | X | ⊚ | ⊚ | ⊚ | X | X [symbol] | X [symbol] |
| 46 | ◯ | ◯ | [symbol] | [symbol] | [symbol] | [symbol] | [symbol] | [symbol] | [symbol] | [symbol] |
| | | | Δ | X | ⊚ | ⊚ | ⊚ | X | X [symbol] | X [symbol] |
| 47 | ◯ | ◯ | [symbol] | [symbol] | [symbol] | [symbol] | [symbol] | [symbol] | [symbol] | [symbol] |
| | | | Δ | X | | ⊚ | ⊚ | ⊚ | Δ | Δ |

[symbol]

indicates data missing or illegible when filed

| | [symbol] | | | | [symbol] | | | | | |
|---|---|---|---|---|---|---|---|---|---|---|
| No. | [symbol] | [symbol] | [symbol] | [symbol] | [symbol] | [symbol] | [symbol] | [symbol] | [symbol] | [symbol] |
| [symbol] | ⊚ | ⊚ | [symbol] | ⊚ | [symbol] | [symbol] | [symbol] | [symbol] | [symbol] | [symbol] |
| | | | ⊚ | | X | ⊚ | ◯ | X | Δ | Δ |
| [symbol] | ◯ | ◯ | [symbol] | ⊚ | [symbol] | [symbol] | [symbol] | [symbol] | [symbol] | [symbol] |
| | | | ⊚ | | X | ⊚ | ⊚ | ⊚ | Δ | Δ |
| [symbol] | ⊚ | ⊚ | [symbol] | ⊚ | [symbol] | [symbol] | [symbol] | [symbol] | [symbol] | [symbol] |
| | | | ⊚ | | X | ⊚ | ◯ | ⊚ | Δ | Δ |
| [symbol] | ⊚ | ⊚ | [symbol] | ⊚ | [symbol] | [symbol] | [symbol] | [symbol] | [symbol] | [symbol] |
| | | | ⊚ | | X | ⊚ | ◯ | ⊚ | Δ | Δ |
| [symbol] | ⊚ | ⊚ | [symbol] | ⊚ | [symbol] | [symbol] | [symbol] | [symbol] | [symbol] | [symbol] |
| | | | ⊚ | | X | ⊚ | ◯ | X | Δ | Δ |
| [symbol] | ◯ | ◯ | [symbol] | ⊚ | [symbol] | [symbol] | [symbol] | [symbol] | [symbol] | [symbol] |
| | | | ⊚ | | ⊚ | ⊚ | ◯ | X | Δ | Δ |
| [symbol] | ◯ | ◯ | [symbol] | ⊚ | [symbol] | [symbol] | [symbol] | [symbol] | [symbol] | [symbol] |
| | | | ⊚ | | ◯ | ⊚ | ◯ | X | ⊚ | ⊚ |
| [symbol] | X | X | — | — | — | — | — | — | — | — |
| | | | — | | — | — | — | — | — | — |
| [symbol] | X | X | — | — | — | — | — | — | — | — |
| | | | — | | — | — | — | — | — | — |
| [symbol] | X | X | — | — | — | — | — | — | — | — |
| | | | — | | — | — | — | — | — | — |
| [symbol] | ◯ | ◯ | [symbol] | ⊚ | [symbol] | [symbol] | [symbol] | [symbol] | [symbol] | [symbol] |
| | | | ⊚ | | X | ⊚ | ◯ | ⊚ | ◯ | ◯ |
| [symbol] | ◯ | ◯ | [symbol] | ⊚ | [symbol] | [symbol] | [symbol] | [symbol] | [symbol] | [symbol] |
| | | | ⊚ | | X | ⊚ | X | X | ◯ | ◯ |
| [symbol] | ◯ | ◯ | [symbol] | ⊚ | [symbol] | [symbol] | [symbol] | [symbol] | [symbol] | [symbol] |
| | | | ⊚ | | X | ⊚ | ⊚ | X | ◯ | ◯ |
| [symbol] | ◯ | ◯ | [symbol] | ⊚ | [symbol] | [symbol] | [symbol] | [symbol] | [symbol] | [symbol] |
| | | | ⊚ | | X | ⊚ | ⊚ | X | ◯ | ◯ |
| [symbol] | X | X | — | — | — | — | — | — | — | — |
| | | | — | | — | — | — | — | — | — |
| [symbol] | X | X | — | — | — | — | — | — | — | — |
| | | | — | | — | — | — | — | — | — |
| [symbol] | ◯ | ◯ | [symbol] | [symbol] | [symbol] | [symbol] | [symbol] | [symbol] | [symbol] | [symbol] |
| | | | X | X | X | ⊚ | ⊚ | [symbol] | X [symbol] | X [symbol] |
| [symbol] | ◯ | ◯ | [symbol] | [symbol] | [symbol] | [symbol] | [symbol] | [symbol] | [symbol] | [symbol] |
| | | | X | X | X | ⊚ | ⊚ | X | X [symbol] | X [symbol] |
| [symbol] | ⊚ | ◯ | [symbol] | [symbol] | [symbol] | [symbol] | [symbol] | [symbol] | [symbol] | [symbol] |
| | | | X | X | X | ◯ | ⊚ | X | X [symbol] | X [symbol] |

[symbol]

indicates data missing or illegible when filed

As shown in Tables 1, 2, and 3, the resin composition of the present invention was suitable as a constituting material of the tray for accommodating electronic products. The kneading and molding processing of the resin composition was possible under the temperature of, for example, 290° C. or lower. The HDT of the tray was, for example, 135° C. or higher. The water absorption rate of the tray was, for example, 0.8% or lower. The surface electrical resistance value of the tray was, for example, 1.0×10¹²Ω or lesser. Because the resin composition contained substantially no black antistatic agent such as CP, the problem (e.g., contamination) caused due to the CP, etc., was solved. The tray having high cleanability was obtained. The specific gravity of the tray was, for example, 1.0-1.1. The tray was lighter than the tray made of the resin composition containing CP by about 6-27%. Because the tray was substantially free from the black antistatic agent such as CP, a colorful tray would be obtained (trays of various colors would be obtained depending on the color of the coloring material). Upon storage, etc., of the electronic products, the electronic products could be accommodated, according to the kinds thereof, in (color discriminable) trays having desired colors. Owing to the easy classification, during the production process and the production management of the electronic products, the electronic products are readily discriminable and thus are easy handleable.

### REFERENCE CHARACTER LIST

1 tray (container)
2 storage area (housing space)
6 electronic parts (products)

1. A resin composition, comprising:
an A resin, which is a polyphenylene ether-based resin;
a B resin, which is a styrene-based resin;
a C resin, which is a carbonate-based resin, an acrylic-based resin, an amide-based resin, a butylene terephthalate-based resin, and an ethylene terephthalate-based resin, or a mixture thereof; and
a polymeric antistatic agent,
wherein the polymeric antistatic agent is present in a range of from 5 to 30 parts by mass per 100 parts by mass of the A resin,
wherein the B resin is present in a range of from 5 to 40 parts by mass per 100 parts by mass of the A resin,
wherein the C resin is present in a range of from 30 to 240 parts by mass per 100 parts by mass of the B resin,
wherein the resin composition is substantially free from carbon, carbon fibers, carbon nanotubes, metal powders, and metal fibers,
wherein the resin composition has a HDT of 135° C. or higher,
wherein the resin composition has a surface electrical resistance value of 1.0×10¹²Ω or smaller, and
wherein the resin compound is suitable to be subjected to kneading and molding processing at the temperature of 290° C. or lower.

2. The resin composition of claim 1, wherein the B resin is one or more resin selected from the group consisting of a styrene-acrylonitrile copolymer, a styrene-butadiene copolymer, a styrene-acrylonitrile-butadiene copolymer, an ethylvinylbenzene-divinylbenzene copolymer, an acrylonitrile-styrene-chlorinated ethylene copolymer, an acrylonitrile-styrene-ethylene-propylene-diene copolymer, a polystyrene, a poly chlorostyrene, a poly(α-methyl styrene), and a rubber-modified polystyrene.

3. The resin composition of claim 1, wherein the B resin is one or more resin selected from the group consisting of a styrene-acrylonitrile copolymer, a styrene-butadiene copolymer, a styrene-acrylonitrile-butadiene copolymer, and a polystyrene.

4. The resin composition of claim 1, wherein the B resin is a styrene copolymer.

5. The resin composition of claim 1, wherein the C resin is one or more resin selected from the group consisting of a polycarbonate, a polymethylmethacry late, a polyamide, a polybutylene terephthalate, and a polyethylene terephthalate.

6. The resin composition of claim 1, wherein the polymeric polymer type-antistatic agent is a polyether antistatic agent.

7. The resin composition of claim 1, wherein the polymeric polymer type-antistatic agent has a number average molecular weight of 500 or greater.

8. The resin composition of claim 1, wherein the polymeric antistatic agent is present in a range of from 10 to 25 parts by mass per 100 parts by mass of the A resin.

9. The resin composition of claim 1, wherein the A resin is a homopolymer or a copolymer of a polymer of formula (I): 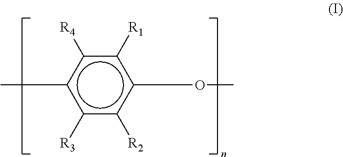
wherein R₁, R₂, R₃, and R₄ are independently H, a halogen atom, a hydrocarbon group, a hydrocarbon-oxy group, a halogenated hydrocarbon group, or a halogenated hydrocarbon-oxy group having at least 2 carbon atoms between a halogen atom and a phenyl ring, and
n is an integer of 20 or greater.

10. The resin composition of claim 1, wherein the resin composition-further contains-comprising:
a compatibilizer,
wherein the compatibilizer is a reactive compatibilizer.

11. The resin composition of claim 10, wherein the compatibilizer is present in a range of from 1 to 20 parts by mass per 100 parts by mass of the A resin.

12. The resin composition of claim 1, wherein the resin composition is further substantially free from surface active agents having an antistatic function.

13. The resin composition of claim 1, having a water absorption rate of 0.8% or lower.

14. The resin composition of claim 1, having a HDT of 135° C. or higher.

15. The resin composition of claim 1, having a surface electrical resistance value of 1.0×10¹²Ω or smaller.

16. The resin composition of claim 1, having a specific gravity in a range of from 1.0 to 1.1.

17. (canceled)

18. A molded body, made of the resin composition of claim 1.

19. The molded body of claim 18, which is a tray configured for accommodating one or more electronic products.
